(19) United States
(12) Patent Application Publication
(10) Pub. No.: US 2012/0319445 A1
(43) Pub. Date: Dec. 20, 2012

(54) SINGLE INPUT AND MULTI-OUTPUT DRIVE SYSTEM UTILIZING AN ACTIVE MATERIAL ACTUATED TRANSMISSION

(75) Inventors: Aragorn Zolno, Whittier, CA (US); James Holbrook Brown, Temecula, CA (US); Nilesh D. Mankame, Ann Arbor, MI (US)

(73) Assignee: DYNALLOY, INC.@@GM GLOBAL TECHNOLOGY OPERATIONS LLC, Detroit, MI (US)

(21) Appl. No.: 13/525,435

(22) Filed: Jun. 18, 2012

Related U.S. Application Data
(60) Provisional application No. 61/497,572, filed on Jun. 16, 2011.
(60) Provisional application No. 61/548,956, filed on Oct. 19, 2011.

(51) Int. Cl. A47C 3/20; F16H 37/06

(52) U.S. Cl. 297/338; 74/665 F; 74/724

(57) ABSTRACT

A single input, multi-output drive system adapted for use, for example, with a power seat, includes an input power source, such as a PMDC motor, and at least one transmission further including a plurality of output elements shiftable between engaged and disengaged conditions relative to the source, so as to be selectively driven thereby, and drivenly coupled, for example, to various functions of the power seat, and a plurality of active material actuators drivenly and individually coupled to an associated one of the output elements, and configured to selectively engage the associated output element and input source.

### RELATED APPLICATIONS

This patent application makes reference to, claims priority to, and claims benefit from U.S. Provisional Patent Application Ser. No. 61/548,956, entitled “HYBRID TRANSMISSION SYSTEM INCLUDING AN ACTIVE MATERIAL AND AN ELECTRIC MOTOR,” filed on Oct. 19, 2011, and Ser. No. 61/497,572, entitled “HYBRID MOTOR AND ACTIVE MATERIAL DRIVE HAVING MULTIPLE AND SIMULTANEOUSLY DRIVEN OUTPUTS,” filed on Jun. 16, 2011, the disclosures of which being hereby incorporated by reference.

### TECHNICAL FIELD

The present invention relates generally to drives and multiple output transmissions, and more particularly to a single input drive and multi-output transmission utilizing active material actuation to effect selective engagement between at least one output element and an input source.

### BACKGROUND

It is known in the art to transmit an input force (e.g., from a DC motor, etc.) between multiple outputs; and multiple types of transmission have been developed for doing the same. They include clutches, gearboxes, flex tubes, and more. Selective engagement of these output mechanisms with the input driveshaft have conventionally been performed using electro-mechanical or magnetic devices. However, these devices present various concerns including the generation of lag, noise (both acoustically and with respect to EMF), as well as added complexity, mass, power consumption, and packaging requirements. As such, these provisions are often foregone in favor of multiple input sources. In the automotive arts, for example, multiple motors are typically used to drive various components even where proximally located. In an exemplary setting, FIG. 1 shows a conventional automotive seat 1 comprising a cushion adjustment motor 2, fore and aft adjuster motor 3, recliner motor 4, and lumbar motor 5. Each of these components is controllable in at least two directions, with the cushion often being moveable in four to eight directions—fore/aft, up/down, and tilt, and extension/retraction. Other controllable seat features include backrest side bolsters, which can be moved in/out, and/or inflated/deflated, and cushion side bolsters. Incorporating multiple motors, however, present further concerns in the art, such as reduced packaging space, added mass, and accordingly increased costs of manufacture and operation.

These and other concerns of traditional power-seating assemblies are addressed by the technology described herein.

### SUMMARY

Responsive to the aforementioned concerns, the present invention presents a single input and multiple output drive system that utilizes active material, and more preferably, shape memory alloy (SMA) actuation to effect selective and/or simultaneous outputs. The invention is useful for mitigating the concerns associated with conventional multiple output transmissions and multi-motor applications, including reducing costs and mass in comparison to purely electro-mechanical counterparts, as well as concerns relating to multiple input (e.g., motor) systems. In a preferred setting of the invention, an SMA actuated transmission is used to route power from a single motor to multiple power seat features, wherein the various features can be operated simultaneously or sequentially. Thus, the invention is further useful for combining the advantages of a PMDC motor (e.g., high continuous power output, reversible motion, low cost, etc.) with those of SMA actuators (e.g., low mass, low package size, quiet operation, high energy density, etc.).

The present disclosure relates to a system for selectively transferring work from an input component, such as a drive shaft or worm gear, to multiple output components, by the selective activation an actuator employing an active material. As an example, the active material is in some embodiments a shape memory alloy (SMA). When the active material is activated, it causes motion of an activating component, such as clutch or locker to which it is connected, directly or indirectly, which in turn causes engagement between the corresponding input component and output component, thereby transferring work between the input and output components.

In some embodiments, the assembly includes clutch components and actuator components for actuating the clutch or locker. The clutch components include a locker, and more specifically a locker pin element. The actuator components include a shape memory element arrange to selectively move an engagement element such as a fork element, as described in more detail below and shown in the appended figures. The locker is rigidly connected, in at least one degree of motion (e.g., rotational) to an output component. The locker is configured and positioned so that when the actuator element (e.g., fork) moves in a first direction, it pushes against the locker, which in turn pushes the locker pin element into engagement with the input component (e.g., drive gear), thereby placing the input and output components into engagement, whereby movement of the input component translates to movement of the output component corresponding to the locker actuated.

In some embodiments, the system preferably includes a plurality of such assemblies, each of which being connected to the same input component, or to respective input components, wherein the one or multiple input components are connected for receiving power from a motor. The motor may be, for example, an electric motor. A particular type of electric motor is a permanent-magnet direct current (PMDC) motor.

When the assemblies include gearing, which can be referred to as a gearbox, regardless of the configuration of any housing or gears therein, the assemblies can be referred to as actuator/gearbox assemblies.

While the present technology may be implemented in a wide variety of contexts, the technology is described herein primarily in connection with power-seating assemblies, such as of an automobile. Another exemplary use is in connection with components of an adjustable sunroof of an automobile, or windows, mirrors, or cameras thereof.

Other aspects of the present invention will be in part apparent and in part pointed out hereinafter.

### DESCRIPTION OF THE DRAWINGS

A preferred embodiment(s) of the invention is described in detail below with reference to the drawings of exemplary scale:

FIG. 1 is a perspective view of a conventional automotive seat comprising a plurality of motors for driving separate component functions;

FIG. 2 is an elevation of a hybrid single input source, multiple output drive system, including first and second transmissions, in accordance with a preferred embodiment of the invention;

FIG. 3 shows a perspective view of a hybrid transmission system according to the present technology including an actuator assembly and a gearbox.

FIG. 4 is an exploded view of the gearbox of the system shown in FIG. 3.

FIG. 5A is a cut-away view of the system showing clutches, or lockers, of the gearbox disengaged from corresponding output gears of the gearbox.

FIG. 5B is a cut-away view of the system showing clutches of the gearbox disengaged from corresponding output gears of the gearbox.

FIG. 6 shows a close-up perspective of one of the clutches.

FIG. 7A shows a close-up perspective of a cutting element of the clutches.

FIG. 7B shows a close-up perspective of a pin element of the clutches.

FIG. 8 is a perspective view of an actuator assembly of the hybrid transmission system.

FIG. 9 shows the components of the actuator assembly, with a focus on a strain relief and an engagement element thereof, and introducing a bias element (e.g., springs).

FIG. 10 shows another perspective view of components of the actuator assembly, notably including a photo interrupter.

FIG. 11A shows a gearbox according to an alternative embodiment, without the gears.

FIG. 11B shows an input, worm-gear section of the alternative gearbox without the gears.

FIG. 11C shows an output, actuator-section of the alternative gearbox without the gears.

FIG. 12 shows an output element, including a clutch arrangement of an alternative embodiment.

FIG. 13 shows a side elevation of the output element shown in FIG. 12, within a case.

FIG. 14 shows an elevation of an additional gearing arrangement that can be used to select a direction of output shaft rotation with respect to input drive rotation.

FIGS. 15A-C are perspective views of components of an alternative embodiment of a gearbox for use in the present invention.

FIG. 16 is a perspective view of the output gear of the gearbox of the hybrid transmission system of FIGS. 15A-C.

### DETAILED DESCRIPTION

As required, detailed embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to employ the present disclosure.

A detailed description of a motor driven drive and multiple output transmission that utilizes active material, and more preferably shape memory alloy (SMA) actuation to effect selective and simultaneous outputs is presented in this application. The present invention is particularly suited for use with shape memory alloy; however, it is certainly within the ambit of the invention to supplant the shape memory alloy element described herein with an equivalent on-demand actuated active material. For example, it is appreciated that a magnetostrictives elastomer, electroactive polymer, ferromagnetic SMA element, etc. may be used in the presented and similar configurations. Moreover, it is appreciated that changes to the mechanical relationship of parts to effect mechanical advantage may be made by those of ordinary skill in the art; for example, a greater plurality of gear sets, gears having larger ratios, radially engaging clutch mechanisms, etc. could be used as well. Finally, alternative drive sources may be used besides a PMDC motor, for example a pneumatic piston, or solenoid may be used.

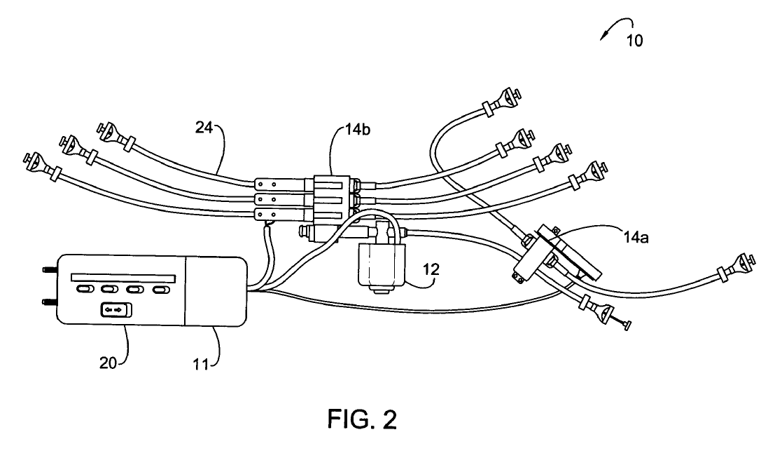

The invention generally concerns a single input, multi-output drive system 10, including an input power source (e.g., PMDC motor) 12, and an active transmission 14 (FIG. 2). Whereas the invention is described as having a single input source 12, it is certainly within the ambit of the invention to use or combine multiple systems 10 and therefore to use more than one source 12 (e.g., in repetitive fashion). Moreover, it is appreciated that alternative energy supplies may contribute to a single source 12.

The transmission 14 presents a plurality of output elements 16 shiftable between engaged and disengaged conditions relative to the source 12, so as to be selectively driven thereby, and a plurality of active material driven actuators 18, wherein each actuator 18 is drivenly and individually coupled to an associated one of the elements 16. The source 12 and transmission 14 are cooperatively configured such that each change causes an associated one of the output elements 16 to shift between the conditions. As used herein the term “active material” is defined as those materials or composites that exhibit a reversible change in fundamental (i.e., chemical or intrinsic physical) property when exposed to or precluded from an activation signal.

In a preferred embodiment, and as further described below, the transmission 14 may include a plurality of gears; and the output elements 16 may further include a plurality of clutches, wherein each clutch is operable to engage and disengage an associated one of the gears, and each actuator 18 is configured to cause each clutch to engage the associated one of the gears when the active material is activated. The output elements 16 may further include a biasing member drivenly coupled to each of the clutches antagonistic to the actuator 18, and operable to cause the clutch to disengage the associated gear when the actuator is deactivated. The source 12 may be drivenly coupled to an input gear, wherein the transmission 14 includes an output gear, and first and second idler gears drivenly coupled to the output gear and selectively engagable with the upper and lower halves of the input gear respectively. The output elements 16 are each selectively engaged with the output gear, while the output and idler gears define translationly fixed centroids that are securely connected to a drive plate, and the transmission further includes idler engaging actuators operable to cause the plate to rotate in the clockwise and counter-clockwise direction, so as to selectively and alternately engage the idler and input gears. The preferred idler engaging actuators may also include first and second SMA wires drivenly coupled to the upper and lower half of the plate.

More particularly, the present disclosure describes assemblies for selectively transferring work from an input component, such as an input shaft or worm gear, to an output component, such as a drive gear or shaft, by selectively activating an active material. The active material may include, for instance, a shape memory alloy (SMA). The actuators 18 can be used to translate work from a single input source (e.g., motor) 12 to any number of multiple activities, each corresponding with one of the actuators 18, in place of traditional system including a separate motor for each activity. As a result, for example, n motors+n gearboxes, for driving n power features, can be replace with one (1) motor and n actuator/gearboxes for driving the same n power features.

In some embodiments, a time delay is introduced between activating the actuators 18 and turning on the motor 12. For example, the system 10 may be configured so that the motor 12 turns on only after the associated actuator 18 is turned on.

In some embodiments, when the operator releases a button, all of the actuators 18 turn on and the motor 12 reverses for a short period of time (e.g., 100 ms) to release any pressure built up, e.g., on clutch pins, making it easier for them to release.

Benefits and Advantages

For embodiments of the invention including gears, or more particularly a gearbox, regarding efficiency, trials have shown gains in gearbox efficiency. In some cases the efficiency gain was up to 30%. Such results are attributable to, at least, elimination a double reduction in the gearing of traditional systems. And such results, along with use of a desirable, or optimized, motor allow meeting and in some instances exceeding of present power requirements, such as requirements for operating components of a vehicle seat assembly (e.g., cushion fore/aft movement, cushion tilt, cushion up/down movement, backrest incline/decline, and lumbar movement).

In order to accommodate an off-the-shelf motor, in some embodiments, the present design uses an extra gear stage. A motor can be custom-designed to match the characteristics (e.g. speed-torque) of the application. This will permit the reduction of the extra gear stage and the mechanical transmission losses (e.g., friction) associated with it, thereby increasing the mechanical efficiency of the entire drive.

Exemplary cost savings include those occasioned by obviating cost of much wiring and drive components and electronics of the redundant motor of the previous systems.

Regarding improvements in size, for example, the size of the actuators of the present technology can much less than that of the previous multiple-motor systems. For instance, in some case a single actuator assembly can have a dimension (e.g., height) that is up to or greater than 30% less.

Other benefits of the present technology include a flexibility to perform consistently in a wide temperature range. For example, various embodiments of the technology employ one or both of (i) a high-temperature, or ultra-high-temperature, active material, for use in high-ambient-temperature operating environments, (ii) hardware (e.g., circuitry) and/or software (logic) configured to control an input trigger signal (e.g., electrical current) provided to the active material based on an ambient temperature in the environment of the active material, and (iii) a hot cutoff to limit energy provided to the active material, making is more reliable in a broad range of temperatures.

As describe in more detail below and by the appended figures, the hot cutoff system comprises a photo interrupter. When the shape memory element (e.g., SMA element) has actuated completely, the photo interrupter is triggered, such as by a photo-interrupter flag component, thereby cutting off power supply to the SMA. These components and functions are described in more detail below in connection with the appended figures. After the photo interrupter is triggered, the SMA cools off, thereby elongating and releasing pressure previously exerted on the actuator component (e.g., fork element). A bias component, such as one or more springs, biases the actuator component, and so the clutch, to its disengaged position. The spring force is sufficient to, as the SMA releases its pressure on the actuator component, move the actuator component, and so the clutch toward their default positions. By this resetting, the photo interrupter is reset, as the photo interrupter flag is moved out of triggering position with respect to the photo interrupter. In some embodiments, this causes power to be restored to the SMA element, which causes the SMA to arrest and reverse drooping.

The system can be designed to exploit the hysteresis inherent in the material response of the SMA such that the power cycling described above does not hinder the primary operation of the system. A control circuit can attempt to maintain a constant heating current for the SMA element regardless of variations in the supply voltage. The constant heating current ensures a nearly consistent response from the system independent of supply voltage fluctuations if the ambient temperature remains constant. When the ambient temperature changes, the heating current needed to activate the SMA also changes—the required current goes down when the ambient temperature goes up and vice a versa. The hot cut-off based power cycling described above ensures that the SMA element does not overheat by reducing the duty cycle of the heating current even though its DC values is largely independent of the ambient temperature.

Further regarding efficiency, the present technology has been found to meet and in many cases reduce or greatly reduce response, or lag, times between functions, such as between a user pressing a recline-backrest button, and the backrest actually reclining.

Further regarding noise levels, noise levels will decrease when production materials are used for gearbox and motor versus rapid materials. Careful choice of materials and design of the system can mitigate the noise levels. Examples of modifications include using one polymer and one metal (e.g., brass) gear in a mating pair to produce a mismatch in the stiffnesses thereby increasing the acoustic impedance for propagation of noise.

In some embodiments, the actuators are designed to protect the active material from mechanical overload. In some particular embodiments, this is accomplished using springs and/or levers, and in other particular embodiments this is accomplished without using additional springs and levers. The embodiment described above regarding the normally-engaged design is an example.

By using one, or a limited number of motors compared to traditional systems, there is a benefit of high continuous work output. Another is reversible motion. By effecting multiple power-out features from the one motor, benefits include lower mass and cost, and operation that is the same, if not improved (e.g., noise reduction from multiple motors). The actuators of the present technology are relatively-low mass, relatively-low cost, and of relatively-low size, especially compared to the number of motors that each group of actuators replaces.

The described benefits of the present technology are presented as examples to provide a better understanding thereof, not as an exhaustive listing of all benefits.

Overview of Hybrid Transmission System

Now turning to the figures, FIG. 2 shows a stand-alone embodiment of the invention comprising a motor 12 and first and second transmissions 14a,b, each having a plurality of output elements 16 drivenly coupled thereto. More particularly, an electrical power supply 20 is shown attached to the motor 12, the first transmission 14a includes opposite singular output elements 16, wherein the elements 16 extend from a gearbox 22 and include driven shafts 24. The second transmission 14b includes opposite sets of three output elements 16 with a seventh output extending proximate to the motor 12. As shown, input shafts may be used to deliver the power to the transmission 14, and the electrical power supply may be separately connected to each actuator 18 via conductive leads (FIG. 2).

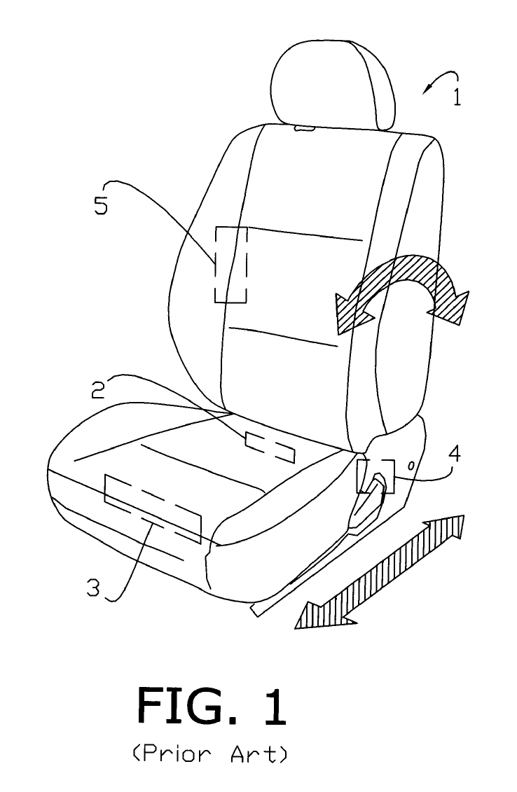

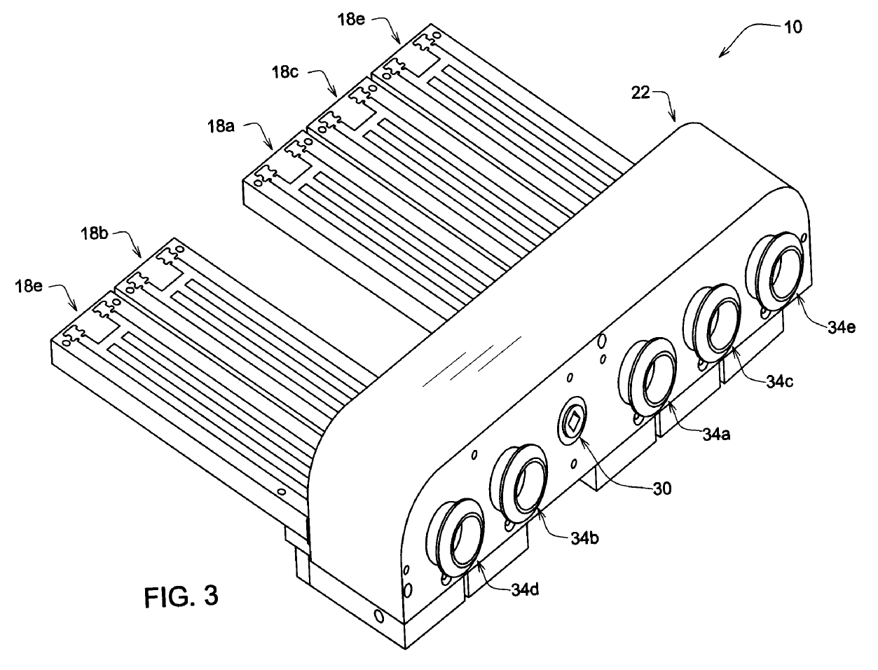

FIG. 3 illustrates the inner-workings of the transmission 14. The system 10 is described primarily in connection with a power seat 1, as conventionally shown in FIG. 1. Along with automobiles, the present technology can be used in other types of vehicles, and home and office furniture, for instance. Another exemplary implementation of the present technology is with adjustable sunroofs, windows, minors, or cameras.

With continued reference to FIG. 3, the system 10 includes multiple actuators 18, or actuator assemblies. Although five actuators 18 are shown, by way of example, the number of actuators 18 is not limited. The number of actuators will at times be referred to herein by the variable n, wherein n is a non-zero positive integer corresponding to any number of outputs desired by a designer of a particular implementation of the present technology. With FIG. 3 being a perspective view of an assembled system 10, it will be appreciated that all of the components of the actuators 18 cannot be seen in FIG. 3, and other components are described in more detail below and shown in subsequent figures.

The hybrid transmission system 10 also includes a gearbox 22. While a gearbox 22 is shown and described, in a contemplated embodiment, the system 10 does not include an actual box, or housing of any type. The actuators 18 may be coupled to one or more gears 26, or at least to a clutch component 28.

As described in more detail below and shown in subsequent figures, selective actuation of any particular of the n number of actuators 18 affects engagement or disengagement of particular clutch components 28 in the gearbox 22, corresponding to the particular actuators 18, with an input component (e.g., input shaft or gear). When engaged, the particular clutches connect the input component to output components corresponding to the particular clutches.

The illustrated components are provided by way of example and the gearbox 22 is not limited to the number or types of gears shown. The gearbox also is not limited to including gears and may include other components for transferring work and power, along with or instead of gears.

The system 10 may include a controller (not shown) for controlling and/or monitoring actuation of the actuator 18.

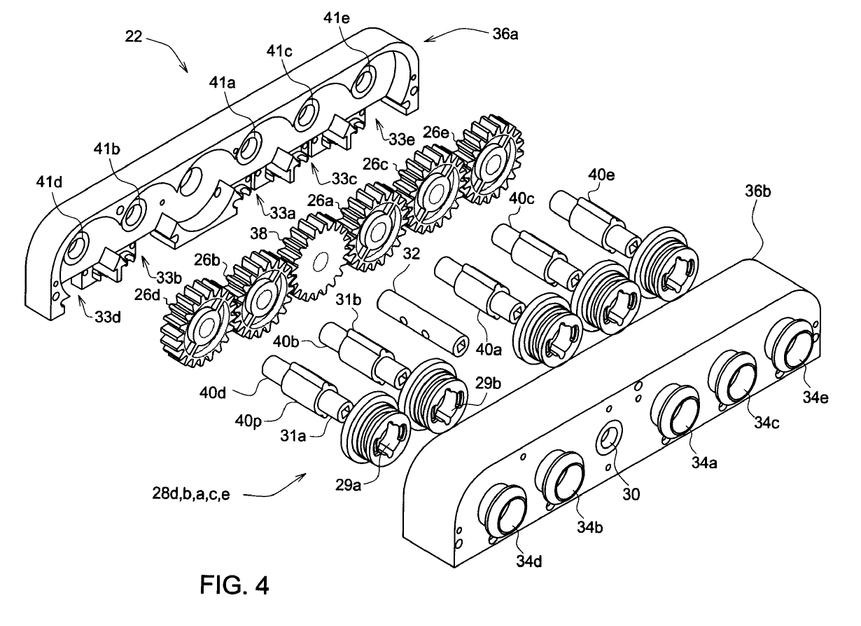

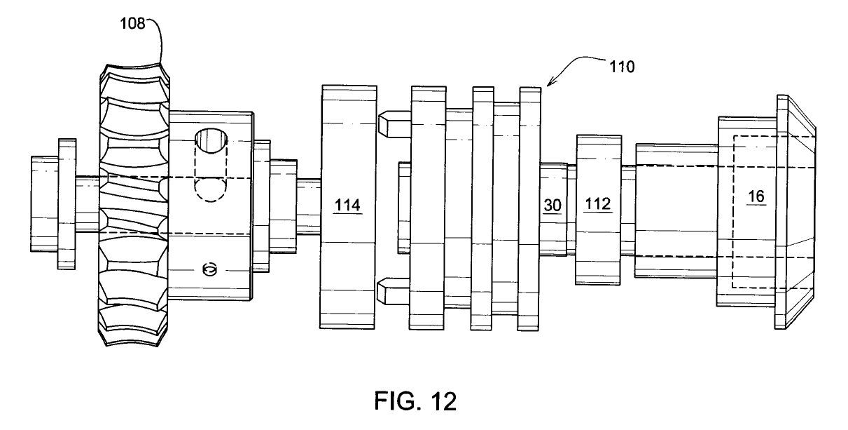

The gearbox 22 includes a motor input opening 30. The input opening 30 is sized, shaped, and positioned to receive at least one input component. More particularly, by way of the opening 30, the input component, such as an input shaft (not shown in FIG. 3; see e.g., shaft 32 in FIG. 4) enters the gearbox 22. The size, shape, and the position of the input opening 30 are not limited. For instance, while the opening 30 is shown positioned generally centrally along a long side of the gearbox 22 in the embodiment of FIG. 3, the opening could be positioned other than centrally or could be positioned on a short side of the gearbox 22. As described in connection with an alternative arrangement shown in FIGS. 12A,B, the input component can include a worm gear and enter at an opening on the short side of the gearbox.

The gearbox 22 also includes output openings 34. As referenced above regarding the number of actuators 18 used, the hybrid transmission system 10 would include n number of openings 34 corresponding to the number of outputs (e.g., shaft 40 in FIG. 4) desired by a designer of any implementation of the present technology.

The output openings 34 are sized, shaped, and positioned to receive output components (not shown in FIG. 3; see e.g., shafts 40 in FIG. 4). The sizes, shapes, and the positions of the output openings 34 are not limited. For instance, while the openings 34 are shown distributed along a long side of the gearbox 22 in the embodiment of FIG. 3, in a contemplated embodiment, at least one of the output openings is positioned on a face of the gearbox 22 that is different than a face at which at least one of the other output openings is positioned.

The output opening 34 can include a fitting for facilitating easy coupling/de-coupling of an output piece (e.g., flex shaft), which carries the output power to a final application.

Turning to the next figure, FIG. 4 shows an exploded view of the gearbox 22 shown in FIG. 3. The gearbox 22 includes a housing 36 surrounding the components of the gearbox 22. The gearbox 22 components include an input component. In the embodiment of FIG. 4, the input component includes an input shaft 32 and input gear 38. As with all parts described or shown as separate components herein, the input shaft 32 and input gear 38 can be separate components, connected together, or one piece, such as by being formed integrally. Similarly, all parts described or shown herein as being unitary, could be comprised of multiple parts.

The input gear 38 of the embodiments of FIG. 4 is a single spur-type gear. However, the type and number of input gear(s), as well as other variables such as size and material, are not limited. In the alternative embodiment referenced above, and shown in FIGS. 12A,B, the input components include a worm 106 and worm gear 108.

The gearbox 22 further includes n number of output gears 26 corresponding to the number of actuators 18 and outputs 16 of the system 10. As provided, the embodiment of FIG. 3 includes five actuators 18, and so five corresponding output gears 26 are shown. For ease of explanation, indicators a-e are used to describe the five groups of components, whereby: the first actuator assembly 18a affects a first of the lockers or clutches 28a for selectively connecting a corresponding first of the output gears 26a to a corresponding first output shaft 40a; a second of the actuators 18b affects a corresponding second clutch 28b for selectively connecting a corresponding second output gear 26b to a corresponding second output shaft 40b; etc.

The input gear 38 and shaft 32 are connected to a drive motor 12. It will be appreciated that, due to the arrangement amongst the gears 38, 26a-e in this embodiment, as shown clearly in FIG. 4, turning of the drive gear 38 causes turnings of the output gears 26a-e.

With particular reference to interaction between the clutches 28 and output shafts 40, for the embodiment shown in FIG. 4, each clutch 28 includes a primary profile 29a (e.g., concave radius) configured to receive a primary profile 31a (e.g., convex radius) of the corresponding output shaft 40. Each clutch 28 also includes a recessed portion, or bushing profile 29b configured to receive a protrusion 31b of the corresponding output shaft 40. By way of the corresponding features 29b, 31b, the clutch 28 and the output shaft 40 turn together.

The gearbox 22 also includes openings 41 for receiving distal ends of the output shafts 40 (FIG. 4). The openings 41 are sized, shaped, and otherwise configured (e.g., by material they include) to facilitate free movement of the output shafts therein.

As described above, engagement/disengagement of the clutches to the output gears is controlled by the respective actuators 18 (shown in FIG. 3). The actuators 18a-e enter the gearbox 22 by way of actuator-input openings 33a-e.

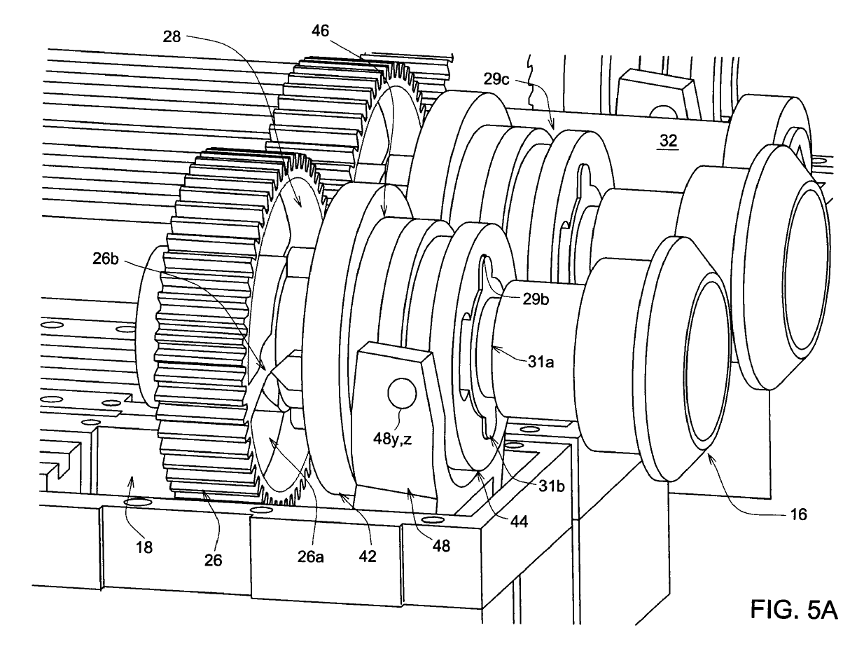

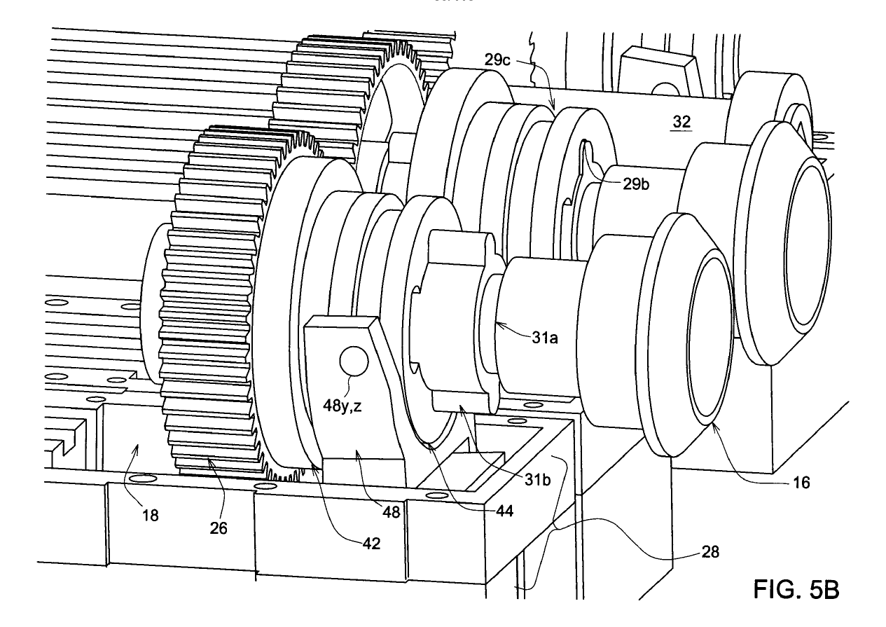

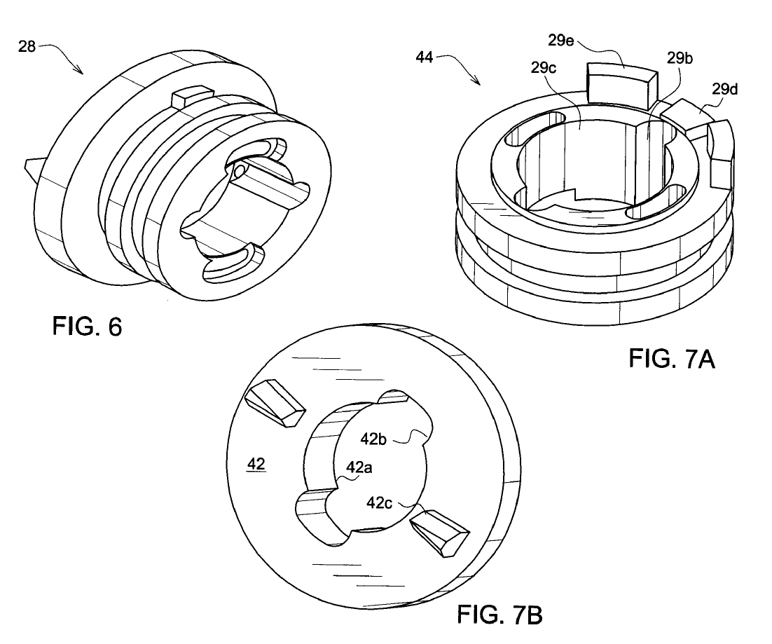

FIGS. 5A,B show close-up views of clutches 28 disengaged from (FIG. 5A) and engaged to (FIG. 5B) corresponding output gears 26.

In operation, in some embodiments, the gears 26 are spinning whenever the motor 19 is running. With an SMA actuator in its OFF state, the corresponding gear 26 spins on the output shaft freely (i.e., without transferring any torque to the output shaft). When the SMA actuator is in its ON state, it causes the output shaft 40 to couple to the corresponding gear 26 via the clutch 28. These functions are described further below.

Each of the clutches 28 can be in the form of a locker. As shown in these figures, the clutches 28 can each include a pin member, pin, or locker pin member 42, and a clutch cutting member 44 (or locker cutting element). The clutch 28 could also include an alignment member 46 connecting the pin 42 and cutting 42.

The alignment member 46 can be, for example, a spring. The alignment member 46 operates to align the pin and cutting members 42, 44 of the clutch 28. The alignment may occur generally continuously, intermittently, or generally whenever possible, while still allowing for rotary misalignment between these components when needed for engagement of the pin, or teeth, of the pin 42 with the mating grooves or ridges of the output gear 26. The alignment member 44 (e.g., alignment spring) can also serve to soften tooth-to-tooth contact during initiation of engagement and the termination of disengagement between the clutch (i.e., pin element) and output gear.

As introduced above, the actuator 18 of the present hybrid transmission system 10 includes an engagement element for transferring work (e.g., motion) from the actuator 18 to the clutch 28. The engagement element of the embodiment shown in FIGS. 5A,B is identified by reference numeral 48 and is in the form generally of a fork. While the engagement member 48 is described primarily in connection with a fork 48, herein, the engagement member may take any of various forms sufficient to transfer work (e.g., motion) of the actuator 18 to the clutch 28.

The fork 48 includes protruding parts, referred to herein generally as knobs or pins 48y and 48z. The knobs 48y,z are configured (sized, shaped, positioned, etc.) to engage the clutch 28. In some embodiments, as shown in FIGS. 5A,B, the knobs 48y,z are configured to engage a groove or other receptacle 29c of the clutch 28.

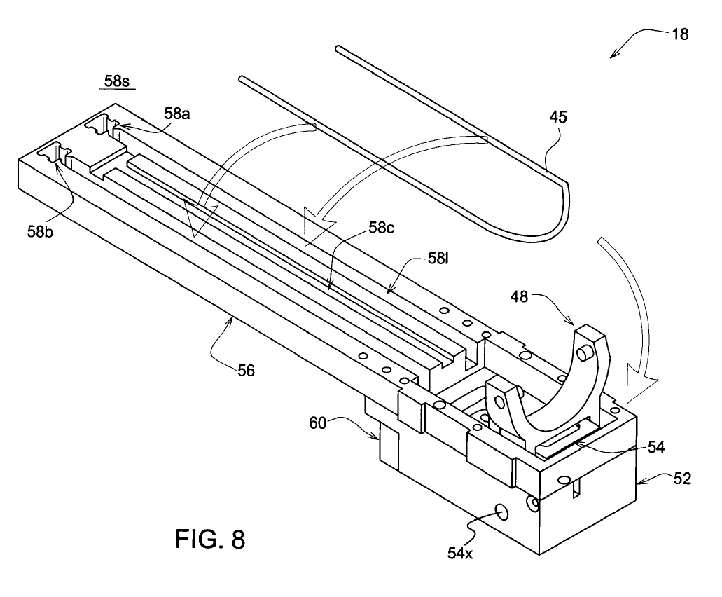

The clutch 28 (e.g., locker) is designed to prevent the active material 45 e.g., SMA wire, (FIG. 8) from having to rotate the gear train in the event that the pins on the locker are directly pushing against stops on the gears.

When the SMA 45 is in its ON state (i.e., operating to engage the output shaft with the gear 26), the pins, or teeth 42c (FIG. 7) of the pin member 42 may either slide into the pocket 26a (FIG. 5A) of the gear 26, or align with a mating tooth 26b on the gear 26, depending on a relative orientation of the pin member 42 and the output gear 26 at a time of initiation of the engagement process. In the latter case, due to a profile of the two mating teeth 42c, 26b, they will seek to slide past each other.

If the SMA 45 was connected to the pin member 42 through a series of rigid connections, during this sliding, the SMA 45 may be required to exert sufficient force to allow the two teeth 42c, 26b to slide past each other to complete the engagement process. This implies that the SMA 45 actuator is driving the output gear through the sliding connection between the mating teeth on the pin member 42 and output gear 26. This could cause the SMA 45 to overload. To prevent this possibility, the SMA 45 actuator is only connected to the cutting member 44 by rigid connections; the cutting member is connected to the pin member 42 via the aligning spring 46. As provided, the spring 46 is configured and positioned to allow a limited misalignment between the output gear 26 and the pin member 42, typically during the engagement/disengagement processes, so that the load on the SMA 45 during these processes is kept down to desired values.

In some embodiments, the locker 28 allows up to 20° of rotation before it begins to transmit power. The locker 28 is returned to an initial position through the use of at least one return spring 50. The entire clutch assembly needs to slide with as little friction as possible on the output shaft 40. Any friction generated at this point has an exaggerated effect on the active material 45 (e.g., SMA)—e.g., up to or greater than three times the friction can end up being experienced by the active material.

FIG. 7A shows a close-up of an example cutting or centering member 44 of the clutches 28. Generally, in some embodiments, the pin member 42 and the centering or cutting member 44 will be lined up or “centered” by the alignment spring 46.

As shown, in addition to the primary profile 29a and bushing profile 29b, described above, the cutting member 44 includes a spring location stop 29d and two symmetric spring deflection limiters 29e.

The location stop 29d is used to locate the spring during assembly and during periods when there is no torque transmitted through the coupling. There is a corresponding stop on the pin member 42 (on the side opposite to that shown in FIG. 7B).

When no torque is transmitted through the coupling, the alignment spring 46 is located by both of these features (stop 29d and corresponding stop on the pin member 42), which serves to align the cutting member 44 and pin member 42 under these conditions. When a load is being transferred through the coupling, the alignment spring 46 deflects to allow a rotational misalignment between the cutting member 44 and pin member 42 to accommodate alignment of the mating pin 42c (or tooth or tab) of pin member 42 with a mating tooth (or ridge or tab) on the corresponding output gear 26.

As discussed above, this feature limits load on the SMA actuator 45, and allows for a smoother engagement process. Once the engagement is nearly complete and the output gear 26 begins to drive the pin member 42, the spring 46 continues to deflect until one of the two symmetric deflection limiters 29e on the cutting member 44 comes into contact with the spring location stop 29d on the pin member 42. The pin and cutting members 42, 44 are now rigidly coupled by this direct-contact interaction until the transmitted torque goes to zero, such as occurs momentarily in connection with a reversal of direction. The direct-contact interaction limits the deflection of the alignment spring 46, and thereby protects the alignment spring 46 from overload.

The cutting member 44 attaches the clutch 28 to the fork 48. The cutting includes a groove or other receptacle 29c. For forming the groove 29c, it could be cut from ¼″ acetal using 1/16″ end mill and ⅛″ end mill. The groove 29c allows this component to rotate while the pins 48y,z in the fork 48 press the locker 28 into the gear 26. This component slides along the bushing or protruded portion 40p (FIG. 4) attached to the output shaft 40 when the fork 48 moves, but cannot rotate due to having a profile 29b similar to the bushing profile of the bushing 40p. The locker spring 46 is prevented from rotating by the stops. When locker pin 42 rotates, it pushes against the locker spring and deforms it; once load is removed from locker pin 42, the spring 46 will align the locker pin 42 and locker cutting member 44.

For formation of the cutting member 44, generally, it can be done in three primary operations. A first operation should cut out the profile of the component, the inner profile, and the spring stops. A second operation should be on the opposite side of the component, cutting out the relief for the #0 screw heads by using a ⅛″ end mill.

A third operation is adding the groove 29c. The third operation is in some cases most critical part of the component. The fork 48 uses two pins or knobs 40y,z, which may be 3/32″ in diameter, to drive the locker through this groove 29c. If the groove 29c is too large, there will be excessive play in the locker and it will not fully engage or disengage. If the groove 29c is too small, the locker will not rotate freely when the actuator is engaged. If the groove 29c is too shallow, the pins will not be able to fit around the diameter. If the groove 29c is too deep, it will penetrate the other features on the locker. If the groove 29c is not flat, the locker will push against the actuator while the motor is running.

The spring 46 for this design is to be cut from ⅛″ acetal (although other materials can be used if they provide more desirable mechanical properties for the spring). A thickness is in some cases the most critical aspect, followed by the inner diameter. The outer diameter is non-critical, but should not be so large that it interferes with the fork 48. The pin member 42 of the locker 28 is in some embodiments to be cut from ⅜″ acetal, such as by using 1/16″ end mill, and then ⅛″ end mill, in two steps.

Regarding formation of the fork 48, it can be cut out of 0.270″ Acetal (0.25″ nominal) using a ⅛″ end mill. Spacing between the legs 481 (FIG. 10) of the fork 48, and a distance from the outside of the legs to the actuator case 52, are important, and in some cases, critical to having a low-friction actuator. Spacing between the legs 481 should allow a strain relief mechanism 54 (or “bell crank”; see FIG. 10) to move freely. The space outside the legs 481 needs to be narrow enough to keep the fork 48 from rubbing on the actuator case 52.

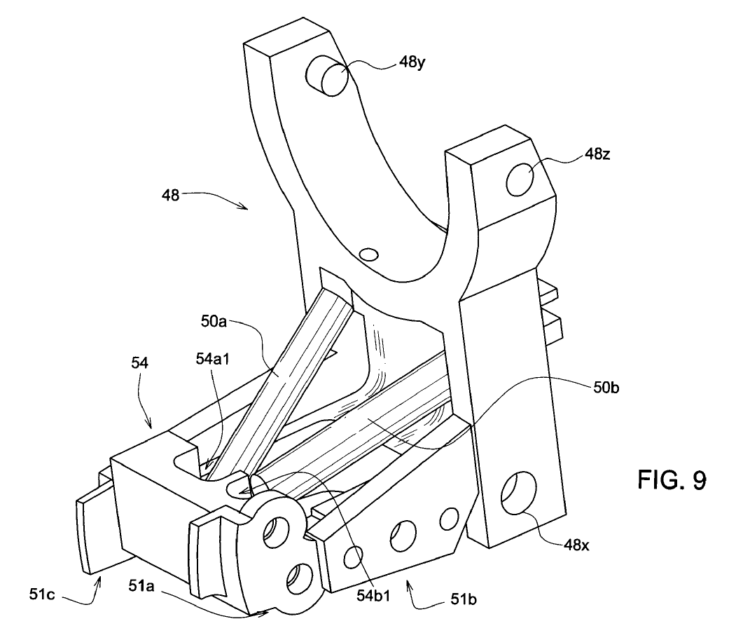

A second formation operation for the fork 48 includes drilling holes 48x (FIG. 9) for the pivot and the pins 48y,z to move the locker 28. Location of these holes 48x is more critical relative to each other than relative to an absolute position on the fork 48. If the holes on the fork 48 are not accurate relative to each other, leverage, force, or displacement can be disturbed; if the holes 48x are not accurate relative to the rest of the fork 48, there might be minor rubbing or smaller problems that can be adjusted. The holes 48x need to be as straight as possible. If the holes 48x are off by more than 0.005″, the fork 48 might not work as desired.

The fork 48 is in one embodiment designed around having two 3/32″ knobs or pins 48y,z pressed into the upper portion of the fork 48 to drive the locker 28. The holes should be a press fit for the pins. The lower holes 48x are for a pivot/axel which is, e.g., a ⅛″ pin. The lower holes in one embodiment have a 0.128″ diameter hole to allow a loose fit on the pin.

The fork 48 can drive the locker 28 using, e.g., 3/32″ pins. The design in some embodiments allows the fork 48 to move approximately 0.120″ horizontally with a vertical change of less than 0.005″. The fork 48 is not directly pulled by the SMA, but is pulled by the spring attached to the strain relief mechanism 54.

A chamfer can be manually added to the fork 48 after the component is cut out. The chamfer allows full motion of the strain relief 52. It needs to be large enough to allow the components of the system 10 to fully move, but it should leave as much material on the fork 48 as possible to prevent twisting.

The fork 48 and the bell crank 54 are held together by a strain-relief spring 50a,b. The spring 50a,b has a preload with a value that is greater than the maximum load needed for normal operation of the system, and less than a desired maximum load, which is dictated by durability considerations for the SMA actuator 45. If an output load acting on the fork 48 causes the load on the strain-relief spring 50a,b to exceed its preload value, the spring 50a,b changes its length, thereby allowing the fork 48 to separate from the bell crank 54. This limits the maximum load that can be transmitted from the fork 48 to the SMA actuator 45 to a desired value controlled by the strain-relief spring 50a,b.

The chamfer is just a relief feature cut into a piece to allow another piece to move relative to the first piece without mechanical interference.

FIG. 7B shows a close-up of an example pin member 42 of each clutch 28 (e.g., locker). As shown, the pin member 42, like the cutting member 44, includes a primary profile 42a and a bushing or oversized profile 42b. The oversized profile 42b is sized and shaped to accommodate the protruding portion (bushing) 31b of the output shaft 40.

The pin member 42 also includes at least one pin 42c. The illustrated embodiment shows two pins 42c by way of example. The pins 42c are configured (e.g., sized, shaped, and positioned) to engage the adjacent output gear 26 when the clutch 28 is moved to its engaged position (shown for example in FIG. 5B). By way of the pins 42c, the pin member 42 engages the adjacent output gear 26 so that rotation of the output gear 26 transfers directly to rotation of the pin member 42, and so the clutch 28 in general. In turn, rotation of the clutch 28 transfers directly to rotation of the output shaft 40, due to engagement between the protruded portion 31b of the output shaft and at least one of the oversized or bushing portions 42b, 44b of the clutch 28.

Turning to the next figure, FIG. 8 shows a perspective view of the actuator 18. The view in FIG. 8 shows the mounting plate 56, containing the shape memory element (SME) or “active material” 45, without showing the cover illustrated on the actuator 18 in FIG. 3. The active material-mounting plate 56 includes active-material recesses, lateral 581 and central 58c, in which the active material 45 (e.g., shape memory alloy (SMA) wire) is disposed during operation of the hybrid transmission system 10.

The active material mounting plate 56 includes two end connections or anchoring points 58a,b at the end of respective lateral recesses 581. At these points, the active material 45 is anchored to the mounting plate 56.

The actuator 18 also includes, at or adjacent at least one of the first and second anchoring points 58a,b, an electrical or thermal source 12. The electrical or thermal source may be for example, connected to a battery for selectively providing an input current to the active material 45, thereby causing the active material to undergo Joule heating, and in response change phases, and thus change shape and/or size.

As described in further detail, below, the active material 45 also selectively affects movement of the clutch 28 (e.g., locker). The active material 45 does this by way of the engaging element 48 (e.g., a fork). The fork form is presented by way of example of an element that engages the clutch 28 on each side of the clutch 28, thereby being able to exert uniform force (e.g., pulling force) on opposite sides of the clutch 28.

The wire mounting plate 56 is in some embodiments cut from 0.25″ acetal. The purpose of this component 56 is to mount the wire 45 (or other rendition for the active material, e.g., ribbon) accurately to the base, and to align the actuator 18 to the gearbox 22.

In formation, the wire mounting plate 56 can be cut in four operations. A first operation is to cut out a main body. Three channels defining the recesses are designed to be cut with a ⅛″ end mill. Ring-terminal holding features can be used to hold the SMA 45 in place, and when they are, they can be designed to be cut with 1/16″ end mill.

There are several holes around the cavity of the actuator 18, some being used to fasten the actuator base and cover, and the others are designed to align this component to the base by using 1/16″ pins. All holes can be drilled with a 1/16″ bit and need to be center drilled. A width of the cavity 56c needs to be wide enough to allow the fork 48 to move freely.

As described, and shown in, e.g., FIG. 8, the actuator 18 also includes a case 52, a photo interrupter sub-assembly 60, and a strain relief 54. The case 52 is sized and shaped to receive at least portions of components of the actuator 18, including the fork 48 and the strain relief 54.

In formation, the case or base 52 of the actuator 18, in some embodiments, is cut from ½″ acetal. The actual depth of the part can be 0.515″ (which is the thickness of ½″ nominal acetal stock). There are, in some embodiments, four operations. A first is cutting out the main body of the case 52. The cavity in this component is designed to be cut from ⅛″ end mill. There are eight holes, the smaller holes are intended to be a press fit for 1/16″ pins, and the larger holes are close fit clearance hole for #2-56 screws. Again, as referenced, the cavity 58c in some embodiments needs to be wide enough to allow the fork 48 to rotate freely.

A second operation can be drilling the pivot hole and the hole and the other hole on the plane. The hole for the pivot is intended to be drilled using a 0.128″ bit. The other hole should be drilled to tap a screw (e.g., having characteristic: #2-56), and could be countersunk. A third operation is drilling holes to mount the photo interrupter mounting plate. A fourth operation is cutting the slot to mount the return spring. The width of this cut, in some embodiments, needs to be wide enough to hook the return spring around a screw (e.g., having characteristic: #2-56).

The active material 45 may include a twisted pair (or more than two) wires. Force exerted by an active material, e.g., SMA wire actuator 45 is proportional to its cross-sectional area. Total output force can be increased by increasing diameter of the active material (e.g., wire). Total output force can also be achieved by using multiple wires arranged mechanically in parallel between a ground anchor and the output load. For ease of packaging, the multiple wires may be arranged into a cable or woven into a braid.

To make assembly easier, ring terminals instead of barrel crimps can be used for anchoring points 58a,b (FIG. 8), whereby the SMA actuators 45 can be anchored to the gearbox case 22, which, in turn, can be ultimately anchored to a primary structure (e.g., seat structure). This obviates the need for installing wire(s) and a fixed set of lead wires. The wire(s) mount to the body at the anchoring points 58a,b. From this point, the lead wires are twisted together and run down the center channel 58c where they exit through a hole before reaching the actuator cavity, and each section of wire runs down its own channel into the actuator cavity.

The cover is purely cosmetic and is not necessary to operate the actuator. The base is aligned to the wire mounting block by using four 1/16″ pins and is fastened by four screws (e.g., having characteristic: #2-56).

The larger hole 54x on the strain relief mechanism 54 is for the pivot, which needs to be a tight fit (0.125″ bit). The three holes to the right of the pivot 54x are for a strain relief stop. The two outside holes (of the three holes) are for 1/16″ pins to align the block, and the middle hole needs to be tapped for a screw (e.g., a #2-56 screw). The two holes on the right side are for spring mounts. The upper hole is a through hole which the return spring connects to, and the lower hole is for the strain relief spring. The flag feature interacts at times with the hot cutoff photo interrupter. The thickness of the flag in some embodiments needs to be thin enough to fit between the legs of a 2 mm photo interrupter 60a,b (FIG. 10).

For manufacture, The strain relief mechanism 54 is designed to be made in four operations. A first operation is cutting out the body from ⅝″ acetal. A second operation in forming the strain relief mechanism 54 is cutting the wire path and the return spring hole(s)—e.g., the two vertically aligned adjacent the anchor point. The wire path is in some embodiments cut using a 1/16″ end mill using an arc on a Y-Z plane. The hole for the return spring(s) is in some embodiments not a critical part of the design and only needs to be wide enough to keep the spring(s) from rubbing on the arm 54 during operation.

A third operation in forming the strain relief mechanism 54 is in some cases necessary for mounting the return, strain relief springs 50, and to provide clearance for the fork 48. The large profile in the center of the body is used to lighten the component and provide enough room to mount the return spring. The exact dimensions of this hole are not critical and just need to be large enough to allow the return spring to not contact the arm while being small enough to leave adequate material on the walls. A pocket(s) is configured to allow the return spring(s) 50 to be mounted. The springs could connect to one or both of the holes in the arm 54. The pockets clear enough room to hook the spring around the material not removed by the pocket. The pocket needs to be large enough to allow the spring to not contact the arm.

Another pocket in the strain relief mechanism 54 allows for clearance of support material on the fork 48. To make the fork 48 stiffer, additional material can be added to a thinnest section, requiring this additional clearance on the strain relief mechanism 54. This pocket should be deep enough to completely clear the material of the fork 48, but not (much) deeper. If the pocket is too large, it could make the wall of the strain relief mechanism 54, adjacent the active material path, too thin. Still another pocket in the strain relief mechanism 54 is for receiving and/or facilitating anchoring of the strain relief spring 50a,b.

In one embodiment, an SMA wire 45 and a return spring/s 50a,b attaches to the strain relief mechanism 54. This arm connects to the fork through the strain relief spring, and attaches to the actuator through a ⅛″ pin. The diameter of the curve the wire bends around is much greater than the 20:1 ratio recommended between bend diameter and wire diameter. As provided, the strain relief is associated with, or includes, a flag for the hot cut off.

In formation, the fork flag 51c can be cut from 0.125″ thick acetal. In some embodiments, a very important portion of the flag is a pocket. This pocket serves two purposes: (i) forming a space (spacer) between the fork 48 and the strain relief mechanism 54, and (ii) causing the flag 51c to rotate with the fork 48. A type of surface of this pocket is in some cases not critical because there will be no relative motion between the pocket and the fork 48.

A location of the edge of the pocket relative to the hole for the pivot is important and, in some cases, critical. If a distance between the pivot hole and the pocket edge is too large, the flag will have undesired play, which can, e.g., cause the flag to prematurely or otherwise undesirably block the photo interrupter 60a,b. On the other hand, if the distance between the pivot hole and the pocket edge is too small, the flag 51c will not sit flush against the fork 48, and so the flag 51c will not sit flush against the strain relief mechanism 54, either, causing unwanted friction.

A thickness of a middle section of the flag 51c should be checked as well. If this section is too thick, it will contact the actuator case 52. If this section is too thin it will reduce the size of the features used to rotate it with the fork 48. As provided, the thickness of the flag 51c on the end needs to be able to fit between the legs of a 2 mm photo interrupter 60a,b. The hole for the pivot is in some embodiments preferably drilled with the same size drill bit used on the fork 48.

In some embodiments, to simplify the electronics a photo interrupter needs to be attached to the fork to indicate when the locker is engaged. Due to the lever design, the fork only moves approximately 0.060″ in the case, while the end of the fork moves twice as far. If the flag is mounted directly on the fork, adjusting the photo interrupter would be very tedious. To make adjusting the photo interrupter easier, a flag mounted to a lever that will amplify the movement of the fork is used. The flag and the pins on the fork move approximately the same distance. The flag is aligned to the fork by using features cut into both components.

The strain relief stop 52b can be cut from either PVC or acetal, for example, especially considering that this component is not intended to slide against any other part. Critical relationships for this component are a location of the three outside holes with respect to the part's upper-right edge. The two outside holes, closest to the edge, could be a press fit for, e.g., a 1/16″ pin. The pins align this component 52b to the strain relief mechanism 54. The center hole of the three can be set for a #2-56 flat head fastener. The center hole can also be counter sunk. The other edges (other than the upper-right edge—i.e., top, bottom, and left edges) are in most cases, non-critical and can be used for tabbing while cutting the stop 52b.

A thickness of the strain relief stop 52b should be such that it will not contact the actuator case 52; if it 52b contacts the case, it will cause undesired friction in the actuator 18. The screw head needs to be completely recessed in the middle hole, and the pins used need to be short enough to not protrude through their respective holes. If the edge is not accurate, the fork 48 and strain relief 54 will not rest in their designed position, and could cause problems with the locker 28.

In formation, the photo interrupter mounting block 60 could be cut from ¼″ acetal, especially considering that the leads for the photo interrupters 60a,b will have to be connected (e.g. soldered) extremely close to the surface of this part.

An important aspect of the photo interrupter mounting block 60 is a profile for the photo interrupters 60a,b. The mounting block should securely hold the photo interrupters without any play. If the photo interrupters are not in the correct location, the flags 51c,a on the strain relief mechanism 54 and the fork 48 should be adjusted.

Small holes where the photo interrupters mount can be designed to be 0.040″ diameter, but can be larger or smaller. Smaller holes are generally thought to be better (up to a point at which the leads no longer fit and/or hold), because the photo interrupters are more likely to be kept in place. Smaller holes, though, require more accuracy in drilling them. For larger holes, the designer should ensure that the photo interrupters cannot move after the leads have been connected (e.g., soldered). The small features that hold the photo interrupters are designed to be cut using a 1/32″ end mill. To save time while cutting, a 1/16″ end mill can be first used to make the majority of a pocket, followed by a 1/32″ end mill to clean up the needed sections. Holes on the outside of the block are used to align the block to the actuator body (lower holes are press fit for 1/16″ pins) and the upper holes are designed to fasten the block to the actuator with a close fit for a, e.g., #0 fastener.

Operation of the fork flag 51c is connected to the motion of the fork 48. This is used to detect whether the fork has rotated through the appropriate distance to allow engagement/disengagement of the corresponding clutch.

During normal operation, there is an overlap in the functionality of these two flags 51a,c. However, during mechanical overload conditions, when motion of the bell crank 54 is decoupled from that of the fork 48, the status of these two flags describes, or reflects, two different aspects of the system's state (e.g., that associated with position of the crank and that associated with the fork).

The photo interrupter 60 acts as a hot cutoff. It includes at least one sensor 60a,b (FIG. 10) for determining when the flag 51a or c moves, with the fork 48, beyond a certain point. An exemplary hot cutoff sensor is a photo encoder or interrupter configured to determine when light passing between portions of the sensor is interrupted by the flag, indicating that the fork 48 has moved sufficiently (i.e., as far as the fork 48 needs to go to do its work of pushing the clutch or locker into its engaged position.

When the photo interrupter/hot cutoff 60a,b determines that the fork 48 has moved sufficiently (e.g., reached its second position), it sends a signal operable to reduce or shutoff the heat source 12 (e.g., electrical or thermal) to the active material 45. The signal may go, for example to the controller (e.g., circuit board or processer). This arrangement has benefits including saving energy by providing only enough as is needed to move the clutch to the second position and then providing only enough to maintain that position for the fork 48. Another benefit of this arrangement is that it, by providing a safety against overheating, allows a high initial input (e.g., electrical or thermal) to the active material 45, thereby causing a quick-response actuation. Thereafter, the input can be lowered appropriately to maintain the desired position. Still another benefit of the hot cutoff arrangement is avoiding over heating of the active material 45, limiting activity, and so wear, of the active material.

In some embodiments, a strain relief that protects the SMA element from mechanical overload conditions is added. The strain relief/mechanical overload protection is useful for normally-disengaged—as opposed to a normally engaged—clutch design/embodiments. These aspects would give a designer of the system an ability to control the material strain and stress. This can be done mechanically in some cases, for instance, or with control electronics or a combination of the two. Basically, in conditions in which the gears are not aligned or the system is loaded in such a way that the active element would be unable to move into position, there would be the mechanism, electronic and/or mechanical, preventing the active material from being damaged.

The hot cutoff logic function, like all control aspects disclosed herein, can be performed partially or fully at the actuator 18, in hardware (e.g., at the circuit board or other controller) and/or software, and partially or fully at a computing device (e.g., vehicle central processing unit) relatively remote to the actuator assembly.

In one embodiment, the position to which the fork 48 and clutch or locker 28 are biased is the disengaged position, wherein the clutch is not engaged to the output gear 26. The biasing element 50 in some embodiments includes one or more springs. Accordingly, the parts indicated by reference number 50 can be considered a springs, and will be referred to herein as such for ease of descriptions. The biasing element may include other biasing parts in addition to or in lieu of springs.

More particularly, the biasing element shown in FIG. 10 includes two springs 50a,b. The springs 50a,b connect at respective first ends to anchoring points of the strain relief mechanism 54. The springs 50 connect at second ends to anchoring points 54a1,b1 of the fork 48. The springs 50 can be any of various types, such as extension or compression springs, and so in these examples biases would operate to bias the fork 48 toward the left or toward the right, respectively, depending on the type of bias.

The active material 45 wraps around the strain relief mechanism 54, at a mid-portion of the active material 45. The strain relief 54 includes a groove for receiving and holding the active material 45 wrapping around the strain relief 54. The groove of the strain relief 54, in which the active material 45 rides, may have a concave chevron-shaped profile for holding the active material 45.

The diameter of the curve of the groove, about which the active material 45 (e.g., wire) bends has in some embodiments a 20:1 ratio, and in some embodiments a great or even much greater ratio, between bend diameter and wire diameter. The relief 54 includes or is connected direction to a flag for hot cut off.

In operation, when the active material 45 of any particular actuator sub-assembly of the actuator 18 is activated, its length shortens. Because the material 45 of that actuator 18 its ends are fixed at the anchoring points, its shortening causes its mid-section, wrapped around the strain relief 54, to pull the strain relief 54 (i.e., pull the strain relief 54 toward the anchoring points. In response, the strain relief 54 slides proximally, toward the anchoring points, thereby causing the corresponding fork 48 to rotate about its axis.

The strain relief spring 50a,b are connected between the bell crank 54 and the fork 48. Both of these components pivot about the same axis. These components are distinct, but move as one component as long as the load on the strain relief spring 50a,b connecting them is less than a preload in the spring. When this preload is exceeded, the spring 50a,b extends, which allows the fork 48 and the bell crank 54 to rotate independently about the same axis.

Because the knobs 48y,z are engaged with the slots 29c of the cutter 44 of the clutch (locker) 28a, the fork 48 rotating causes the cutter 44, and so the locker pin 42, to move toward the corresponding output gear 26a, or any corresponding locker plate that may be intermediate the corresponding output gear 26a and locker pin 42. When the locker pin 42 engages the gear 26a, directly or indirection (e.g., via a plate), rotation of the gear 26a causes corresponding rotation of the clutch 28a (locker). With rotation of the clutch 28a, the output shaft 40a rotates, providing power output from the transmission 14.

In some embodiments, the one or more of the output shafts 40 is in turn connected to a flexible shaft 24, delivering the rotational power to a desired location. Flexible shafts are shown by way of example in FIG. 2. The shafts 24 can be filled partially or substantially completely with lubrication.

The out-and-back arrangement for the active material 45 removes moving lead wires. The strain relief mechanism 54 attaches to the fork 48 through the use of the spring 50a,b, which is selected so that when the wire reaches a certain value for pounds/in², e.g., 40 ksi, the strain relief mechanism 54 can move without the fork. To keep the fork 48 and the strain relief mechanism 54 aligned, the strain relief stop is attached to the strain relief mechanism.

The stop keeps the fork and strain relief mechanism at the designed relationship unless the strain relief is in use. When the flag on the strain relief mechanism 54 blocks the hot cut off photo interrupter, the power to the wire is stopped. When the flag on the fork reaches its photo interrupter, the power for the drive motor is turned on. If the strain relief is used, the flag for the fork will not reach its photo interrupter. With the geometry selected for the actuator, the moment arm of the return spring decreases while the moment arm for the SMA wire increases, as shown in the following table (showing Return spring moment arm by actuator angle), for example:

TABLE 1

| | Spring | |
|---|---|---|
| Angle | Moment Arm | % Difference |
| 0.00 | 0.1799 | 0.0% |
| 0.60 | 0.1773 | −1.4% |
| 1.35 | 0.1741 | −3.2% |
| 1.90 | 0.1717 | −4.6% |
| 2.34 | 0.1698 | −5.6% |
| 2.69 | 0.1682 | −6.5% |
| 3.04 | 0.1667 | −7.3% |
| 3.55 | 0.1645 | −8.6% |
| 3.89 | 0.1629 | −9.4% |
| 4.49 | 0.1603 | −10.9% |
| 5.00 | 0.1581 | −12.1% |
| 5.52 | 0.1558 | −13.4% |
| 6.12 | 0.1531 | −14.9% |
| 6.73 | 0.1504 | −16.4% |

A second table shows SMA moment arm by angle:

TABLE 2

| | Spring | |
|---|---|---|
| Angle | Moment Arm | % Difference |
| 0.00 | 0.1799 | 0.0% |
| 0.60 | 0.1773 | −1.4% |
| 1.35 | 0.1741 | −3.2% |
| 1.90 | 0.1717 | −4.6% |
| 2.34 | 0.1698 | −5.6% |
| 2.69 | 0.1682 | −6.5% |
| 3.04 | 0.1667 | −7.3% |
| 3.55 | 0.1645 | −8.6% |
| 3.89 | 0.1629 | −9.4% |
| 4.49 | 0.1603 | −10.9% |
| 5.00 | 0.1581 | −12.1% |
| 5.52 | 0.1558 | −13.4% |
| 6.12 | 0.1531 | −14.9% |
| 6.73 | 0.1504 | −16.4% |

As the SMA contracts, it gains leverage over the system while the return spring loses leverage. The strain relief spring has a similar design. As the strain relief spring is used, the leverage the spring has on the wire decreases as the SMA contracts further as shown in a third table (showing Strain relief moment arm by angle):

TABLE 3

| | Strain Relief | |
|---|---|---|
| Angle | Spring Moment Arm | % Difference |
| 0 | 0.5416 | 0.0% |
| 0.42 | 0.5403 | −0.2% |
| 1.01 | 0.5383 | −0.6% |
| 1.51 | 0.5367 | −0.9% |
| 2.09 | 0.5347 | −1.3% |
| 2.71 | 0.5326 | −1.7% |
| 3.41 | 0.5303 | −2.1% |
| 4.13 | 0.5278 | −2.5% |
| 4.93 | 0.525 | −3.1% |
| 5.58 | 0.5227 | −3.5% |
| 6.24 | 0.5204 | −3.9% |
| 6.73 | 0.5186 | −4.2% |

FIG. 10 shows another perspective of components of the actuator 18, notably including the photo interrupter 60.

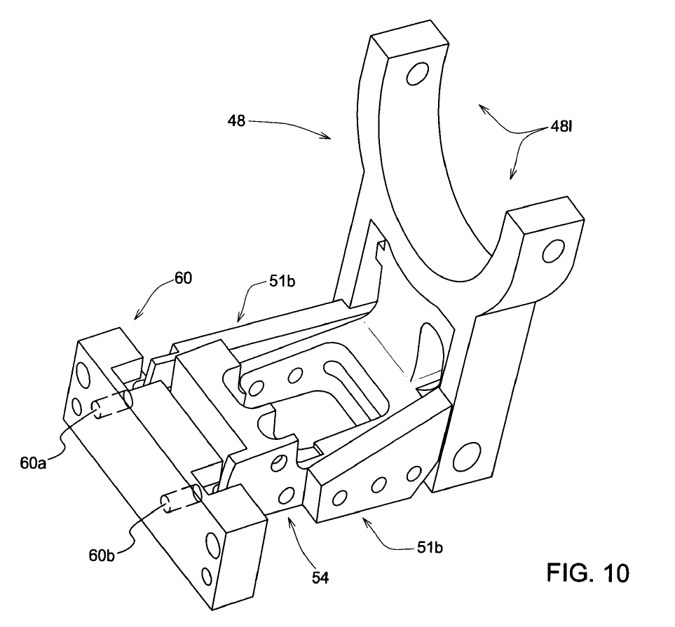

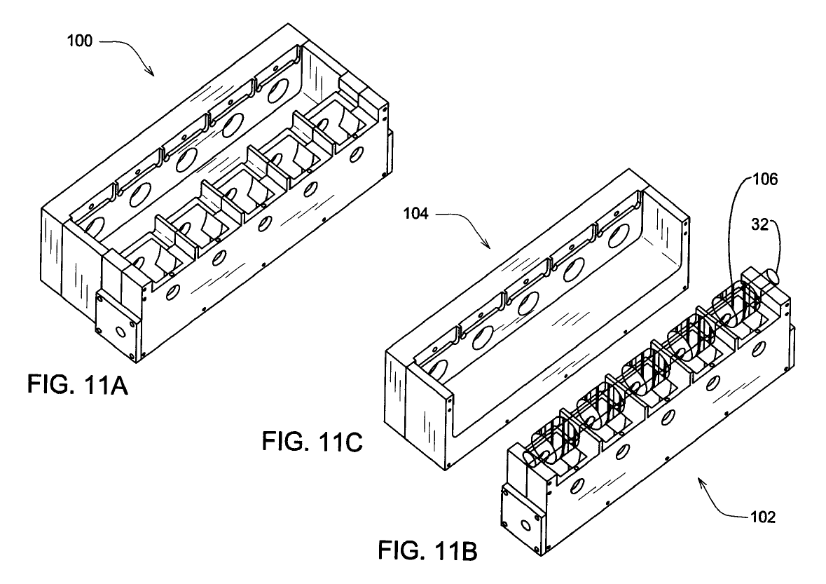

FIG. 11A shows a gearbox 100 according to an alternative embodiment, without the gears. FIG. 11B shows an input, worm-gear section 102 of the alternative gearbox 100 of FIG. 11A, with corresponding input gears being shown. FIG. 11C shows an output, actuator-section 104 of the alternative gearbox without corresponding output gears being shown.

The gearbox 100 is designed around a worm gear reduction. The input shaft 32 can have any number of desired worm sections 106, and is shown having five (5) of them. The shaft is supported at the ends. The gearbox case has an add-in component to mount the bearings to ensure proper alignment of the worm gears 106. This section of the gearbox 100 is aligned to the gear train section of the gearbox through use of 1/16″ pins and to the actuator through the use of features added to the case. This section of the gearbox 100 is required to fully support the output shaft since the output shaft only extends the length of the actuator.

This section consists of two components that form the case, and two that support the input shaft. The case components are aligned by using 1/16″ pins, and the two bearing supports are aligned to the case through the use of features on the body. By having the input shaft independently adjustable from the case allows corrections for misalignment through the replacement of two easy to adjust (by adjusting the part and re-cutting it) components. To help reduce noise in the gear box, where ever possible, cavities were removed

This approach allows the shaft to be fully supported; thrust from the actuator pushing on the plate will be transmitted to the same bushings taking the thrust load from the worm gear. This design allows for some misalignment without affecting noise in the system.

As with the input gears 26 of the embodiment of FIG. 4, the input gears of the second embodiment are selectively engaged by a clutch 110 (FIG. 12). The clutch 110 of this embodiment can be the same as the clutch 28 of the first embodiment, and the clutch can be moved by the same type of actuator system as the actuator 18. This embodiment, as in the earlier embodiment, can include 112 bearings adjacent the output (e.g., bushing).

This gearbox 100 in some embodiments utilizes two high precision bearing (e.g., of type ABEC-7) for the input shaft, ten brass bushings for the intermediate shafts, five general purpose ball bearings and bronze bushings (e.g., five) with a flange for flex shafts on the output shaft. Tests reveal that high precision bearings are in some cases needed for an input speed of about 3000 RPM. Because the intermediate shaft only rotates at 300 RPM, brass bushings are suitable.

Brass bushings are required to have flanges to permit them to take thrust without changing their position in the case. The initial design for the general purpose ball bearings will be reviewed and possibly changed to brass bushings to allow a tighter press fit to take thrust loads from the output shaft. Although these loads should be small (force is dependent on the friction between the locker and the surface it is sliding on), they still need to be accounted for, and ball bearings will not run smoothly if the press fit is too tight.

The clutch 110 can connect directly to the input gear 108 or to a locker plate 114. The locker plate 114 is rigidly connected to the input gear 108, turning with the gear 108. The embodiment of FIG. 4 could also include such a locker plate 114. Accordingly, for that embodiment of FIG. 4, the clutch 28, and more particularly the locker pin member 42, and pin 42c thereof, can selectively engage with a locker plate 114, rigidly connected to the input gear 26, instead of the locker pin being engageable directly to the input gear.

The gear train operates at a designed reduction, such as a 10:1 reduction, with a designed nominal input speed, such as 3000 RPM, and a designed output speed, such as 300 RPM.

All worms 106 are in some embodiments, connected to the shaft 107 (FIG. 11B) independently, which leaves room for individual axial adjustment, with respect to each worm 106 and the common shaft 107. In the gearbox case section 100, the input shaft 107 can be supported by small blocks that can be adjusted to get the correct axis-to-axis positioning/distance. The worm gears 108 (FIG. 12) are adjustable through the use of, e.g., spacers between the faces on the gear 108 and the gears supporting the shafts they turn.

It is possible to adjust the position of the gear axially on the shaft to get proper alignment between the worm and the worm gear, which assists in getting an efficient and quiet drive train.

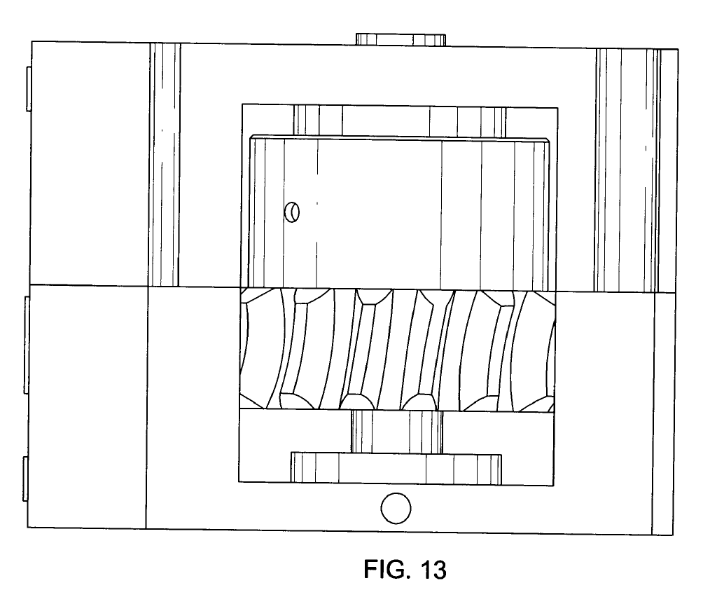

Additional gearing can be added to any of the embodiments described herein. The additional gearing can be configured to effect desired output movements with respect to an input movement. For instance, the gearing can be arranged so that a clockwise input rotation, about an input axis, of an input gear (e.g., the input gears 38, 106 of the embodiments of FIG. 4 or 11-13) can selectively be translated to output rotation in a clockwise rotation about an output axis of an output gear and shaft, or with a counter-clockwise rotation.

In other words, in some embodiments, additional active elements or other elements (e.g., single elements) with multiple positions may be used such that the motor has additional gears for reversing direction of the motor output, and so the direction of respective input gears (e.g., worm) at each actuator assembly. This will allow the user to move multiple features driven by a single, main, drive motor in either opposite or the same direction simultaneously at the same time.

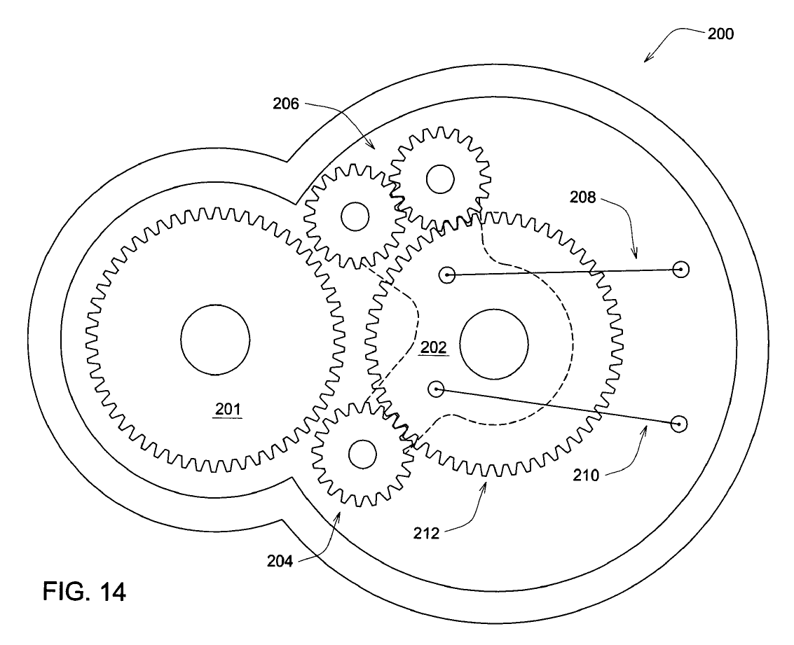

FIG. 14 shows a gearing arrangement 200 including an input gear 201 and a drive plate 202. The drive plate is connected to an idler gear 204 and an idler gear set 206. The arrangement 200 also includes at least a first shape memory element 208 (e.g., an SMA wire) for moving the idler gear 204 and idler gear set 206 into or out of contact with the input gear 201. Action of the first shape memory element 208 can be countered by a biasing element (e.g., spring—not shown) and/or a second shape memory element 210.

Depending on positioning of the drive plate 202, and so the idler gear and set 204, 206, the idler gear 204 or set 206 is caused to contact both the input gear 201 and an output gear 212. When the idler gear or idler gear set 204, 206 contact both the input and output gears 201, 212, rotation of the input gear is translated by way of the idler gear or set 204, 206 to the output gear. The connection causes the output gear to rotate in one direction, or the other, depending on the direction of the input gear 201 and whether it is the idler gear 204 or idler gear set 206 connecting the input and output gear 201, 212.

The input gear 201 is driven by a single motor (e.g., motor 12) and used to drive multiple functions, with at least two of which requiring output rotation in opposite directions, one corresponding to a rotation direction of the motor/input gear 201 and the other rotating in an opposite direction. The input gear 201 is connected to the output gear through the use of idler gears. Direction 1 will use a single idler gear, Direction 2 will use two idler gears.

FIG. 14 shows the gearing system in a neutral state. In this state, the drive plate 202 is held in the disengaged state by one or both active elements 208, 210 and/or by a centering bias element (e.g., spring; not shown). The input gear 201 can rotate freely without driving the output gear. When there is a centering bias element, both strands of SMA are not activated for this neutral state.

FIG. 2 shows schematically that the system 10 may include one or more controllers 11, such as a computer processor or other controlling device. The controller 11 may be partially or fully positioned local to the actuator, power supply 20 (as shown), or remotely. The controller 11 can include a circuit card (not shown in detail).

The controller 11 is used to selectively cause actuation of the actuators 18. The controller 11 may also be used to monitor operation of the devices. Although the controller 11 is shown schematically, and disconnected from the actuators, the controller 11 is in communication with each of the actuators. The controller 11 is in some embodiments also in communication with the motor 12 for monitoring and/or controlling operation of the motor 12. In one embodiment, a separate controller controls and/or monitors the motor. There are different types of motor encoders that can be used to relay position to the control unit. Along with better position control and development to the control algorithm pinch protection would also be improved.

The controller 11 may include a tangible, non-transitory, computer-readable storage medium. The storage medium, or memory, is communicatively connected to a tangible, non-transitory computer processing unit, or processor. The memory and processor communicate by way of a communication media, such as a computing bus.

The memory stores computer-readable instructions. The instructions, which may be stored in one or more modules, are configured to be processed by the processor to perform various monitoring and control functions of the present technology. These functions are described in more detail below.

While components of the controller 11 are shown together, any of the components may be positioned adjacent another of the components or remote to the other component. For instance, while the memory is illustrated schematically as being adjacent the processor, the memory may be in portion of the hybrid transmission system 10, or of the greater vehicle, remote from the processor. In one embodiment, at least two of the components of the controller 11 communicate with each other wirelessly. For example, each of these components (e.g., memory and processor) could include a wireless transceiver for communicating with each other wirelessly. Wireless communications may be effected via short-range wireless technologies.

Benefits of having some of the logic and/or decision making structure at or closer to the actuator 18 (e.g., at the circuit board) include quicker response time. Benefits of having some of the logic and/or decision making structure separated from the actuating assembly 18 (e.g., at a central processing unit of the vehicle) include cost savings, from using existing resources and avoiding need to add resources at the assembly 18.

In one embodiment, a microcontroller (e.g., controller 11) is supplemented by or replaced with a self-aligning mechanical clutch design. This would eliminate command-execution lag due to soft start/stop.

In some embodiments, the active material 45 is a phase-change material, such as a shape memory alloy (SMA). Other exemplary active materials include electroactive polymers (EAPs), piezoelectric materials, magnetostrictive materials, and electro-restrictive materials.

Shape-memory alloy is the generic name given to alloys that exhibit the unusual property of a strain memory, which can be induced either mechanically or thermally. This unusual property is characterized primarily by two thermo-mechanical responses known as the Shape-Memory Effect (SME) and Superleasticity.

Exemplary alloys include copper alloys (CuAlZn), nickel-titanium-based alloys, such as near-equiatomic NiTi, known as Nitinol, and ternary alloys such as NiTiCu and NiTiNb. A particular exemplary allow includes NiTi-based SMAs. NiTi-based SMAs one or the best, if not the best memory properties—i.e., readily returnable to a default shape, of all the known polycrystalline SMAs. The NiTi family of alloys can withstand large stresses and can recover strains near 8% for low cycle use or up to about 2.5% for high cycle use. This strain recovery capability can enable the design of SMA-actuation devices in apparatuses requiring the selective transfer of torque from a torque generating device to each of a plurality of output shafts.

In an Austenite, or the parent phase of an SMA, the SMA is stable at temperatures above a characteristic temperature referred to as the Austenite finish (A_{f}) temperature. At temperatures below a Martensite finish (M_{f}) temperature, the SMA exists in a lower-modulus phase known as Martensite. The unusual thermo-mechanical response of SMAs is attributed to reversible, solid-state, thermo-elastic transformations between the Austenite and Martensite phases.

Another function associated with the actuator 18, performed partially or fully at the actuator assembly and/or remote to the assembly, and partially or fully in hardware or software, is a constant current function. This function is configured to regulate an input voltage to keep it at about a desired voltage. As an example, the constant current function regulates effective voltage to be at a desired about 13V even as an actual input voltage varies between 9V and 16V, such as due to various or varying voltage source qualities and/or voltage requirements of an automobile in which the actuator 18 is positioned.

Another function of the actuator 18, is a temperature-compensation function. This function affects an amount of input (e.g., electricity or thermal) to the active material based on a temperature at or adjacent the actuator 18. The function may receive the temperature from any of a variety of sources, including (i) a low-cost thermistor in the actuator (e.g., connected to the circuit board 11), (ii) a vehicle temperature gage, such as a gage positioned and configured to measure temperature of the vehicle adjacent a roof, and (iii) the active material 45, itself. Regarding the latter, the actuator 18 would include features for measuring aspects of the active material 45 indicative of ambient temperature adjacent the active material. The aspects of the active material 45 indicative could be, for example, resistivity, or a measure of elongation.

Benefits of the temperature-compensation function include maintaining a consistent user experience, including response time, irrespective of the temperature at or adjacent the active material 45, and in some cases saving power. Thus, for instance, if the ambient temperature is 20 degrees below average, the temperature-compensation function would determine that a correspondingly higher input (e.g., electric or thermal) should be provided to the active material 45, at least initially, to cause and maintain the desired response time, and limit lag. Similarly, if the ambient temperature is 20 degrees higher than average, the temperature-compensation function would determine that a correspondingly lower input (e.g., electric or thermal) can be provided to the active material 45 to cause and maintain the desired response time, and limit lag. In the latter scenario (higher-than-average temperature), at least, power is conserved as less than is usually provided is actually provided, while the desired result is still, consistently, provided.

It is appreciated that where two motors are utilized on the input side of the system 10, their output could be combined (used in parallel, together), prior to or at the gearbox, all of the time or selectively (e.g., combined only when higher strength is needed).

In one embodiment, the system 10 has a primary motor sized only for a subset of the total operation requirements and a secondary motor that selectively boosts the primary one only during the ‘heavy lift’ phases. This may be a better (lower cost, mass, noise, etc) solution for some applications. The controller described herein, for example, could control this select combination.

While the gearbox 22, 100 may have other dimensions without departing from the scope of the present disclosure, in one embodiment the gearbox has a length of about 183 mm (measured left-to-right) and a height of 61 mm (measured top-to-bottom).

In a third embodiment of the present technology, a singular transmission including an actuator assembly 18 and a gearbox 22 may be used. Functions of this embodiment include generating a higher (e.g., higher than used in other embodiments or traditional systems) output rpm (revolutions per minute) per input rpm. For example, a lower input rpm can be provided (having benefits such as reduction of noise and vibration) resulting in about the same or higher output rpm. Or the same input rpm can be provided resulting in higher output rpm.

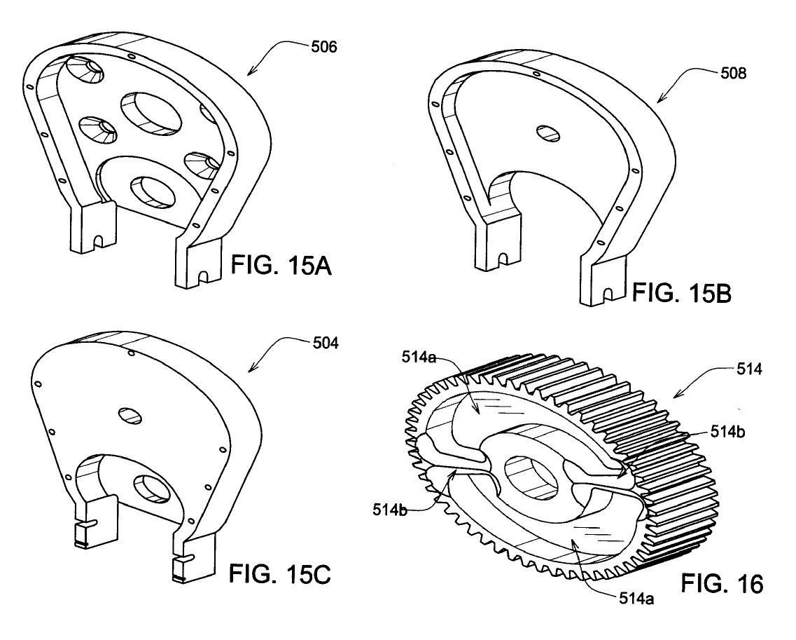

The system of this embodiment includes an actuator component, which can be substantially the same as the actuator component 18 of other embodiments. The system 10 also includes a unique gearbox and a singular output gear 514 (FIGS. 15-16).

The gearbox includes a front cover 504, a rear cover 506, and could also include a spacer 508 (FIGS. 15A-C). The spacer 508 can be used, e.g., to make the gear box large enough to enable the fork to move the required distance.

An output shaft, press fit key (or bushing, or protruded portion), and output gear 514 can be generally the same as those shown and described above in connection with other embodiments.

The output gear 514 can be, e.g., of a type having the following characteristics: 48 pitch, 54 teeth, and a 14.5° PA. A pitch diameter of the gear should be set to certain value. For instance, in some embodiments, it is important to have the pitch diameter of the gear 514 be larger than an outer diameter of the fork (e.g., fork 48); in this way, multiple gears and forks can be positioned adjacent each other.

The gearbox 502 also includes an input gear (not shown). The motor input gear receives drive from the motor (e.g., motor 12 in FIG. 2), and transfers the drive to the output gear 514. The input gear is connected to a shaft coming from the motor. The gear can be, e.g., a type of gear having the following characteristics: 48 Pitch, 81 teeth, and a 14.5° PA. A ratio between the output gear 514 and the input gear can be, e.g., 1.5:1. It has been found that such certain features of the gear help allow a flex shaft (output shaft) to operate within its limits.

FIG. 28 is a perspective view of the output gear 514 of the gearbox 502 of the hybrid transmission system of FIG. 15. Spaces or pockets 514a and pins/teeth 514b of the output gear 514 are shown, and are analogous to the pockets and teeth 26a,b of the first embodiment.

In addition, the technology in some embodiments includes a clutch system within a clutch. In devices where the force to engage and disengage a locking mechanism is too great to be directly driven by a small active element, it would be possible to use a small active element to engage a clutch; the small active element causes driving of a larger clutch or locking mechanism. This could also be applied to further miniaturize the current size actuators. The small active element can be a pilot. The clutch can be a servo controlling work flow.

It is possible to put a type of individual sensor (e.g., electrical, mechanical or both) into each gearbox to separate the load and/or motion feedback signal going to the master control unit. If the feedback signals associated with each output can be kept separate then better pinch protection control can be achieved when driving multiple features. Specifically, different pinch protection threshold levels can be specified for the different features and the computational cost associated with pinch protection can be reduced thereby reducing the microprocessor resources needed for this system.

A second concept has applications in situations in which torque transmitted through the clutch would otherwise be higher than desired for individual SMA elements to provide the engagement (or disengagement) force for the clutch. The concept uses the motor itself to not only provide the torque that drives the output load but also provide the force/torque for engaging the clutch. An SMA actuator element would only provide a small force/torque that would divert the necessary force/torque from the motor to perform the disengagement/engagement.

When an output feature is disengaged/engaged, the motor provides a force/torque not only to drive the output but also to sustain disengagement/engagement. As the motor shaft, in some embodiments, needs to rotate continuously to drive the output, but only rotate through a finite angle to perform the disengagement/engagement, a type of slipping clutch (e.g., a friction clutch) can be used to allow a finite torque/force to be channeled from the motor to perform the disengagement/engagement corresponding to a finite rotation of the motor shaft while still allowing the motor shaft to rotate continuously to drive the output.

As the motor itself can provide much higher force/torque than a compact SMA element, this concept allows the technology to be applied even when the disengagement/engagement load can vary over a wide range, making the system more robust in this way.

If the disengagement/engagement is effected by the motor being tapped, the resulting design can in some cases be smaller, more compact.

Target applications for this concept include those requiring transmission of a large torque through the clutch, such as is usually the case when the output applications require a large amount of work and/or power.

The controller 11 can monitor three feature positions by either incrementing or decrementing a position count value by polling the encoder's status at intervals, such as every five milliseconds.

Upon interrupt, the controller first determines whether the motor is in the OFF, DIRECTION 1 (e.g., seat cushion fore movement), or DIRECTION 2 state (e.g., seat cushion aft movement). If the motor is in the OFF state, the encoders are ignored and the stall-counters are cleared.

When the motor is in the DIRECTION 1 state, the controller determines which actuators are disengaged and the transmission hence engaged. The engaged encoders respective stall-counters are incremented and if their state has changed from the previous polling:
1. The position count is decremented;
2. The state flag is set to the opposite logic; and
3. The stall-count is cleared.

When the motor is in the DIRECTION 2 state, the controller determines which actuators are disengaged and the transmission hence engaged. The engaged encoders respective stall-counters are incremented and if their state has changed from the previous polling: 1. The position count is incremented, 2. The state flag is set to the opposite logic and 3. The stall-count is cleared.

Each time an individual transmission is disengaged, a Motor Bump routine preferably takes place. The Motor Bump determines the current direction of the motor and runs it in opposite direction for a small (typically around 100 ms) and predetermined amount of time. This reversal of direction removes the load from the transmission and allows the actuator to return with little force necessary.

When operating in either the Supervised or Express Close mode, Pinch Protection is enabled. The Pinch Protection feature monitors the Motor's current and collects a running average. An offset value is preset and when the current value exceeds the running average plus the offset, a Pinch is detected. When this occurs, the Motor Stops immediately and reverses direction for a small amount of time to relieve the obstruction. The user is notified of this error mode.

In a traditional drive, which has one motor driving one power feature, the anti-pinch feature is typically implemented by setting an absolute limit on the current drawn by the motor. This limit acts as a threshold, which when crossed, triggers the anti-pinch functionality on that particular feature. This approach is generally viewed as inapplicable to the present technology in which a single motor is used for driving multiple features, possibly simultaneously.

For example, assume that hypothetical features 1, 2 and 3 have normal (e.g., allowable) current draws of I1, I2 and I3 amperes, respectively, when they are being driven independently. Further, let I1′, I2′, and I3′ be the corresponding anti-pinch thresholds and I1+I2>I1′. Then, when features 1 and 2 are being driven simultaneously, the normal motor current draw exceeds the anti-pinch threshold for feature 1 being driven independently. Thus, the absolute motor current draw limits used to implement anti-pinch functionality in traditional power seating systems, or other (e.g., sunroof assemblies, windows, minors, cameras) drives cannot be used with our invention without the use of additional sensors beyond a current draw sensor for the single motor. Additional sensors (e.g., force or motion sensors on each mechanical moving element), for instance, can help in this situation and be a beneficial design choice.

A challenge of implementing the anti-pinch functionality in the framework of the proposed invention while still using only a motor current draw sensor can be addressed in the following manner. The controller monitors current drawn by the motor and computes a moving average of the last m samples. This is the baseline I_{b}(t) used for the anti-pinch functionality—the time dependence of the baseline is shown explicitly to emphasize that the baseline itself is changing with time as different features are added or dropped from the set of currently active outputs. The anti-pinch threshold (Iₐₚ(t)) is specified as some function of an absolute or fractional increase over the baseline I_{b}(t). Iₐₚ is, therefore, also a function of time. Basing the anti-pinch threshold on a time dependent baseline compensates for changes induced in the normal current draws for the various features due to various factors, such as changes in ambient temperatures, age and wear of the system components, etc. The approach is also scalable—little/no modification is needed as more features are driven by a single motor.

The Initialize Mode sets the various eat component positions (e.g., backrest incline/decline, and defines the encoder count for the direction 1 and direction 2 positions for the rest of the operating modes.

Thus, various embodiments of the present disclosure are disclosed herein. The disclosed embodiments are merely examples that may be embodied in various and alternative forms, and combinations thereof.

The law does not require and it is economically prohibitive to illustrate and teach every possible embodiment of the present claims. Hence, the above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A single input, multi-output drive system, comprising:
an input power source; and
a transmission including
a plurality of output elements shiftable between engaged and disengaged conditions relative to the source, so as to be selectively driven thereby; and
a plurality of actuators, wherein each actuator is drivenly and individually coupled to an associated one of the elements, and employs an active material operable to undergo a reversible change in fundamental property when exposed to or occluded from an activation signal, so as to be activated and deactivated respectively,
said source and transmission being cooperatively configured such that each change causes an associated one of the elements to shift between the conditions.

2. The system as claimed in claim 1, wherein the source is a PMDC motor.

3. The system as claimed in claim 1, wherein the transmission includes a plurality of gears.

4. The system as claimed in claim 3, wherein the transmission includes a plurality of output gears selectively coupled to the output elements and drivenly coupled to an input gear.

5. The system as claimed in claim 4, wherein the input gear is a worm gear comprising multiple worm sections.

6. The system as claimed in claim 3, wherein the elements further include a plurality of clutches, each of said clutches is selectively operable to selectively engage and disengage an associated one of the gears, and each actuator is configured to cause each of said clutches to engage the associated one of the gears when the actuator is activated.

7. The system as claimed in claim 6, wherein the elements further include a biasing member drivenly coupled to each of said clutches antagonistic to the actuator, and operable to cause each of said clutches to disengage the associated one of the gears when the actuator is deactivated.

8. The system as claimed in claim 3, wherein the source includes an input gear fixedly coupled to the source, and the transmission includes an output gear, and first and second idler gears drivenly coupled to the output gear and selectively engagable with opposite halves of the input gear respectively, and the elements are each selectively engaged with the output gear.

9. The system as claimed in claim 8, wherein the output and idler gears are securely connected to a drive plate, and the transmission further includes idler engaging actuators operable to cause the plate to rotate in the clockwise and counter-clockwise directions, respectively, so as to selectively and alternately engage the idler and input gears.

10. The system as claimed in claim 9, wherein the idler engaging actuators include first and second wires drivenly coupled to opposite halves of the plate.

11. The actuator assembly of claim 1, wherein each actuator includes a locker-type of clutch intermediately coupled to the material and the associated one of the elements, and operable to selectively inter-engage the input source and the associated one of the elements.

12. The actuator as claimed in claim 11, wherein the output elements each include an output shaft defining a primary shaft profile, and each clutch includes a cutting member defining a clutch profile and a pin member, wherein the profiles enable the cutting and pin members to engage the shaft, when the material is activated.

13. The system as claimed in claim 1, wherein each actuator includes a strain relief mechanism to which the active material is connected and operable to drive only where exceeding a predetermined load.

14. The actuator assembly of claim 1, wherein each actuator includes a pivotal fork component drivenly coupled to an associated element, and driven by the material.

15. The system as claimed in claim 14, wherein the fork is drivenly coupled to a clutch communicatively coupled to the associated one of the output elements, and oppositely to a strain relief mechanism.

16. The actuator assembly of claim 1, further including with respect to each actuator a photo interrupter operable to limit movement of the actuator.

17. The system as claimed in claim 1, wherein the active material is selected form a group of materials consisting essentially of a shape memory alloy, an electroactive polymer, a piezoelectric material, a magnetostrictive material, and an electrostrictive material.

18. A power seat adapted for use by a user, comprising:
a plurality of manipulable structural components;
a single input, multi-output drive system, including
an input power source; and
at least one transmission including
a plurality of output elements, each individually shiftable between engaged and disengaged conditions relative to the source, so as to be selectively driven thereby, and drivenly coupled to a structural component, so as to cause said component to manipulate when driven by the source; and
a plurality of shape memory alloy actuators, wherein each actuator is drivenly and individually coupled to an associated one of the elements, and operable to undergo a reversible change in fundamental property when exposed to or occluded from an activation signal, so as to be activated and deactivated respectively,
said source and transmission being cooperatively configured such that each change causes an associated one of the elements to shift between the conditions.

19. The seat as claimed in claim 18, wherein the components include a cushion, backrest, and lumbar support, and the output elements are configured to cause cushion fore/aft movement, cushion up/down movement, cushion tilt movement, backrest incline/recline movement, and lumbar support adjustment.

20. The seat as claimed in claim 18, wherein each output element includes a flexible shaft extending to an associated component.
